(19) United States
(12) Patent Application Publication
(10) Pub. No.: US 2003/0144119 A1
(43) Pub. Date: Jul. 31, 2003

(54) Measuring sensor in a paper machine

(76) Inventors: Georg Kleiser, Schwabisch Gmund (DE); Jens Muller, Heidenheim (DE); Rainer Fenske, Giengen (DE)

Correspondence Address: Todd T. Taylor, TAYLOR & AUST, P.C., 142 S. Main St., P.O. Box 560, Avilla, IN, 46710, US

(21) Appl. No.: 10/352,738

(22) Filed: Jan. 28, 2003

(30) Foreign Application Priority Data
Jan. 29, 2002 (DE) 102 03 321.8

(51) Int. Cl. B05C 1/08; B25F 5/02

(52) U.S. Cl. 492/10; 492/9; 492/48

(57) ABSTRACT

A synthetic roll shell, as well as its manufacture and utilization in press rolls, used for the purpose of measuring the pressure progression in a press nip of a machine for the production and/or conversion of a paper, cardboard, tissue or other type of fiber web.

The pressure measurements are made during rotation of the press roll by at least one pressure sensor located in the synthetic material.

### BACKGROUND OF THE INVENTION

1. Field of the Invention

The present invention relates to a device, the method of production of the device, and the method for using the device, for measuring the pressure progression in a press nip of a fiber web production or conversion machine. More particularly it relates to a roll shell of partially synthetic material for a rotating press roll of a paper, cardboard, tissue, or other type of fiber web production or conversion machine.

2. Description of the Related Art

The only possible method of quantitatively capturing the pressure progression in the press nip of deflection controlled press rolls is the evaluation of the hydrodynamic film between the roll shell and the support device, that is, generally the support shoe. However, this requires permanent installation in the press rolls and bores in the support shoe. This is relatively expensive.

What is needed in the art is a device and method to measure the pressure progression in the press nip simply.

### SUMMARY OF THE INVENTION

The present invention provides a roll shell for a press roll where at least one pressure sensor is present in the synthetic material of the shell. This pressure sensor detects the pressure exerted upon the synthetic material of the roll shell during a run through the press nip. This pressure is an indication of the pressure exerted upon the material web running through the press nip and can be used to evaluate problems. This measuring device is of simple construction and associated with a high degree of accuracy.

In order to be able to detect the pressure progression axially along the press nip, there should be several pressure sensors located in the synthetic material, preferably at least distributed axially across the roll shell. In addition, the pressure sensors can also be distributed radially across the roll shell, thereby expanding the measuring range.

In the interest of a contemporary evaluation and a simple and reliable measuring device, a data transmitter that should preferably be located in or on the roll shell, should be assigned to the pressure sensor. Each pressure sensor could have its own transmitter, or alternatively several pressure sensors could share one data transmitter.

The installation of the measuring device is possible with a variety of roll shells. However, the roll shell should consist predominantly, or preferably totally of synthetic material and/or have at least one outer layer, preferably the outside layer constructed of synthetic material.

Particularly in a situation where the roll shell consists predominantly or totally of synthetic material, it normally comprises reinforcing elements, preferably in the form of reinforcing threads. These reinforcing elements increase the mechanical load capacity and the deformation or distortion resistance of the roll shell. With regard to a secure positioning of the pressure sensor it is advantageous if the pressure sensor is connected with at least one reinforcing element.

In order to be able to generate the press pressure in the press nip while taking a pressure measurement, a support device should be located between the axis of the press roll and the roll shell.

According to the present invention, the method for the production of the roll shell is characterized in that the pressure sensor is cast into the roll shell or into the synthetic layer. This is relatively simple and also allows for the data transmitter and/or an electrical connection to the data transmitter to be cast into the roll shell during manufacture, together with the pressure sensor.

In order to utilize the roll shell in press rolls for measuring the pressure progression in a press nip it is essential that the press roll is used only for a limited time as a measuring roller in the machine. This allows utilization as required, in several machines, thereby reducing expenditure even further.

A data receiver to receive the signals from the data transmitter should be located outside the roll shell or even outside the press roll.

An advantage of the present invention is that the pressure progression in the press nip can be measured simply.

Another advantage is that the measurement device can be cast into the roll shell or a synthetic layer of a roll shell during its fabrication.

Yet another advantage is that the roll shell with measuring device can be used intermittently in the machine.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic partial cross section through a press nip;

FIG. 2 is a schematic partial longitudinal section through the press nip; and

FIG. 3 is a schematic cross section through another press arrangement.

Corresponding reference characters indicate corresponding parts throughout the several views. The exemplifications set out herein illustrate embodiments of the invention, in one form, and such exemplifications are not to be construed as limiting the scope of the invention in any manner.

### DETAILED DESCRIPTION OF THE INVENTION

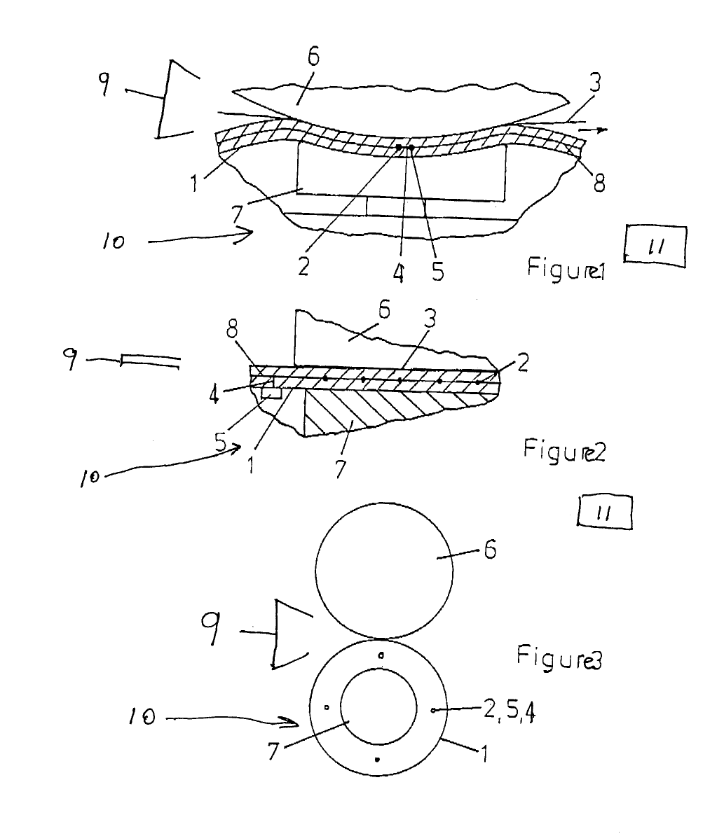

Referring now to the drawings, and more particularly to FIGS. 1 and 2, there is shown an embodiment of the measuring device according to the present invention which generally includes fiber web 3, together with possibly at least one continuous revolving belt, for example a press felt, may be run through press nip 9 that is formed by press roll 10 and backing roll 6. While backing roll 6 has a cylindrical shape, press roll 10 that is installed for measuring purposes has a flexible roll shell 1. Roll shell 1 is pressed against backing roll 6 via support device 7 that is located between roll shell 1 and the press roll axis. Support device 7 is a hydraulically activated support shoe that has a concave contact area in order to create an extended press nip 9, together with backing roll 6. Since, during rotation, roll shell 1 is exposed to an enormous stress due to distortion in the area of press nip 9, roll shell 1 is reinforced by reinforcing elements 8 in the form of axially and radially positioned reinforcing threads.

In order to be able to measure the pressure progression in press nip 9, several pressure sensors 2, located axially beside each other, are cast into roll shell 1. These pressure sensors 2 are connected with data transmitter 5 via electrical connection 4 that is also cast into roll shell 1.

In both instances, pressure sensors 2 are connected mechanically with reinforcing threads of element 8 in roll shell 1, so that a location is ensured already during the casting process. In the example in FIG. 1 data transmitter 5 was cast into roll shell 1 together with pressure sensor 2, and each data-transmitter 5 is assigned to a specific pressure sensor 2. Data transmitter 5 in FIG. 2 is installed on the outside surface of roll shell 1. According to FIG. 2 several or even all pressure sensors 2 are connected with only one data transmitter 5, whereby the data transmitter 5 is located outside support device 7, at the end of roll shell 1 and electric connection 4 runs along the reinforcing threads of element 8.

The data from transmitter 5 may be received by a data receiver 11 located in press roll 10 but outside of roll shell 1, or completely outside of press roll 10.

FIG. 3 illustrates press nip 9 through which neither fiber web 3, nor a belt is run while measuring the pressure progression in press nip 9. In addition, backing roll 6 and press roll 10 have a cylindrical shape, whereby the pressure forces are introduced through the shafts of press roll 10 and backing roll 6. Here, press roll 10 is equipped with a synthetic roll shell 1 that supports itself on a support device 7 in the form of the roll shaft. Since, in this instance, there is no distortion of roll shell 1 as in the previous examples, no reinforcing elements are necessary in the synthetic material. Several measuring units, pressure sensor 2, electric connection 4 and data transmitter 5, are cast into the synthetic material, distributed axially and radially.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A roll shell for a rotating press roll, comprised at least partially of a synthetic material including at least one pressure sensor located in said synthetic material.

2. The apparatus of claim 1, wherein said at least one pressure sensor comprises a plurality of pressure sensors distributed at least axially across said roll shell.

3. The apparatus of claim 1, including at least one data transmitter assigned to said at least one pressure sensor and located in said roll shell.

4. The apparatus of claim 1, including at least one data transmitter assigned to said at least one pressure sensor and located on said roll shell.

5. The apparatus of claim 1, wherein said roll shell consists predominantly of said synthetic material.

6. The apparatus of claim 5, wherein said roll shell consists totally of said synthetic material.

7. The apparatus of claim 1, wherein said roll shell includes at least one outer layer constructed of said synthetic material.

8. The apparatus of claim 7, wherein said at least one outer layer of said roll shell constructed of said synthetic material is an outermost layer.

9. The apparatus of claim 1, wherein said synthetic material includes at least one reinforcing element.

10. The apparatus of claim 9, wherein said at least one reinforcing element comprises reinforcing threads.

11. The apparatus of claim 9, wherein said at least one reinforcing element is connected mechanically to said at least one pressure sensor.

12. The apparatus of claim 1, including a support device located between an axis of said press roll and said roll shell.

13. A method of manufacturing a roll shell, including the step of casting at least one pressure sensor into said roll shell.

14. Method in accordance with claim 13, wherein said at least one pressure sensor is cast into the synthetic material of said roll shell.

15. Method in accordance with claim 13, wherein at least one data transmitter is cast into said roll shell.

16. Method in accordance with claim 15, wherein at least one electrical connection connecting said at least one data transmitter to said at least one pressure sensor is cast into said roll shell.

17. A method of using a roll shell in a press roll for measuring the pressure progression in a press nip of a machine for the production of a fiber web, including the step of using said press roll for a limited period as a measuring roller.

18. Method in accordance with claim 17, wherein said production comprises conversion.

19. Method in accordance with claim 17, wherein a data receiver for receiving signals from a data transmitter is located outside said roll shell.

20. Method in accordance with claim 18, wherein said data receiver is located outside said press roll.
